(19) United States
(12) Patent Application Publication
(10) Pub. No.: US 2025/0182308 A1
(43) Pub. Date: Jun. 5, 2025

(54) DIRECTIONAL FLOW AXIS OBJECT CONTROL

(71) Applicant: Adobe Inc., San Jose, CA (US)

(72) Inventors: Ashish Jain, Ashok Vihar (IN); Arushi Jain, Ashok Vihar (IN)

(73) Assignee: Adobe Inc., San Jose, CA (US)

(21) Appl. No.: 18/527,933

(22) Filed: Dec. 4, 2023

(51) Int. Cl. G06T 7/543; G06F 3/0481; G06F 3/04845; G06T 1/60; G06T 3/60; G06T 7/12; G06T 7/181; G06T 7/37; G06T 7/62; G06T 11/20

(52) U.S. Cl. CPC G06T 7/543; G06F 3/0481; G06F 3/04845; G06T 1/60; G06T 3/60; G06T 7/12; G06T 7/181; G06T 7/37; G06T 7/62; G06T 11/203; G06T 2200/24; G06T 2207/20104; G06T 2210/12

(57) ABSTRACT

Directional flow axis object control techniques are described. In one or more examples, a set of points are obtained by an object-aware edit system. The set of points define locations associated with an object in a user interface. The object-aware edit system defines a polygon based on the set of points. A plurality of boundary candidates is generated by the object-aware edit system based on the polygon and a boundary is selected from the plurality of boundary candidates. A directional flow axis is detected by the object-aware edit system based on the boundary and is used to control an edit operation of the object in the user interface. Caching techniques are also described to cache the directional flow axis for corresponding objects to support real time implementation of the edit operations by the object-aware edit system.

### BACKGROUND

Digital image design as supported by image processing systems often involves arrangement of objects within the digital image. Objects, for example, are commonly arranged, positioned, sized, and rotated are part of achieving a desired artistic effect within the digital image.

In some instances, however, a shape of the object is complex. The shape of the object, for instance, may include a border having irregular segments, may have curved segments that are not uniform, and so on that cause technical challenges in conventional techniques used by image processing systems to support assisted arrangement of the objects. Consequently, conventional techniques typically rely on manual interaction in these scenarios, which frequently results in visual inaccuracies, computational inefficiencies in computing devices that support the image processing systems, and user frustration in real world scenarios.

### SUMMARY

Directional flow axis object control techniques are described. In one or more examples, these techniques support automatic edit operations based on a directional flow axis detected for an object. A set of points, for instance, are obtained by an object-aware edit system. The set of points define locations associated with an object in a user interface. The object-aware edit system defines a polygon based on the set of points, e.g., as a convex hull. A plurality of boundary candidates is then generated by the object-aware edit system based on the polygon and a boundary is selected from the plurality of boundary candidates. A directional flow axis is detected by the object-aware edit system based on the boundary and is used to control an edit operation of the object in the user interface. Caching techniques are also described to cache the directional flow axis for corresponding objects to support real time implementation of the edit operations by the object-aware edit system.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ directional flow axis object control techniques described herein.

FIG. 2 depicts a system in an example implementation showing operation of a directional flow axis detection module of FIG. 1 in greater detail as detecting a directional flow axis of an object in a digital image.

FIG. 3 depicts a system in an example implementation showing operation of a point input module of FIG. 2 in greater detail as obtaining a set of points.

FIG. 4 depicts a system in an example implementation showing operation of a polygon generation module of FIG. 2 in greater detail as defining a polygon based on the set of points.

FIG. 5 depicts a system in an example implementation showing operation of a boundary candidate generation module of FIG. 2 in greater detail as generating a plurality of boundary candidates based on the polygon of FIG. 4.

FIG. 6 depicts a system in an example implementation showing operation of a boundary selection module and an axis detection module of FIG. 2 in greater detail as detecting a directional flow axis.

FIG. 7 depicts an example algorithm describing minimum area rectangle detection following generation of the convex hull and definition of the plurality of boundary candidates.

FIG. 8 is a flow diagram depicting an algorithm as a step-by-step procedure in an example implementation of operations performable for accomplishing a result of detection of a directional flow axis of an object and control of an edit operation based on the directional flow axis.

FIG. 9 depicts a system in an example implementation showing operation of an object-aware edit system of FIG. 1 in greater detail as employing an axis cache to support storage of directional flow axis generated by the directional flow axis detection module.

FIG. 10 depicts a system in an example implementation showing operation of the edit operation module of FIG. 9 in greater detail as implementing an edit operation based on a directional flow axis.

FIG. 11 depicts an example algorithm illustrating creation of angular bins for use by the axis cache.

FIG. 12 depicts an example algorithm illustrating use of the axis cache as part of an angular directional rotation snapping operation.

FIG. 13 is a flow diagram depicting an algorithm as a step-by-step procedure in an example implementation of operations performable for accomplishing a result of directional flow axis caching in support or real time edit operations.

FIG. 14 illustrates an example system generally at that includes an example computing device that is representative of one or more computing systems and/or devices that implement the various techniques described herein.

### DETAILED DESCRIPTION

### Overview

Digital image design as supported by image processing systems typically involves arrangement of objects within the digital image. In some instances, however, a shape of the object is complex, e.g., is not uniform, is curved, has an irregular border, and so on. Consequently, the shape of the object introduces technical challenges involved in incorporating the object as part of the digital image, e.g., to be visually consistent with other objects in the digital image.

Consider an example in which objects are to be aligned in a user interface along a particular axis. Conventional techniques are based on a bounding box, straight segments of a shape of the objects, and so on. In some scenarios, however, the object departs from alignment with the bounding box (e.g., is skewed within the bounding box), does not include straight segments, has a complex shape, and so forth. Accordingly, these conventional techniques often result in visual inaccuracies that depart from user expectations and involve manual interaction to correct these inaccuracies, which is inefficient and introduces additional challenges caused by reliance on a user's skill to correctly implement.

Accordingly, directional flow axis object control techniques are described. In one or more examples, these techniques support automatic rotational edit operations (e.g., snapping behaviors, visual guides) by detecting a directional flow axis of an object. Through automated detection of the directional flow axis, these techniques overcome conventional technical challenges through an ability to address objects having complex and irregular shapes, which is not possible in conventional techniques. The directional flow axis detected by an object-aware edit system for the objects is shape aware.

Therefore, in a scenario in which an object is rotated, moved within a threshold distance of another object, and so on the directional flow axis of the object is compared with the directional flow axis of other objects by the object-aware edit system. The object-aware edit system then causes movement of the object such that it is “snapped” to align the directional flow axes, one with another, in a user interface. Further, caching techniques are also described to cache the directional flow axis for corresponding objects to support real time implementation of the edit operations by the object-aware edit system.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Directional Flow Axis Object Control Environment

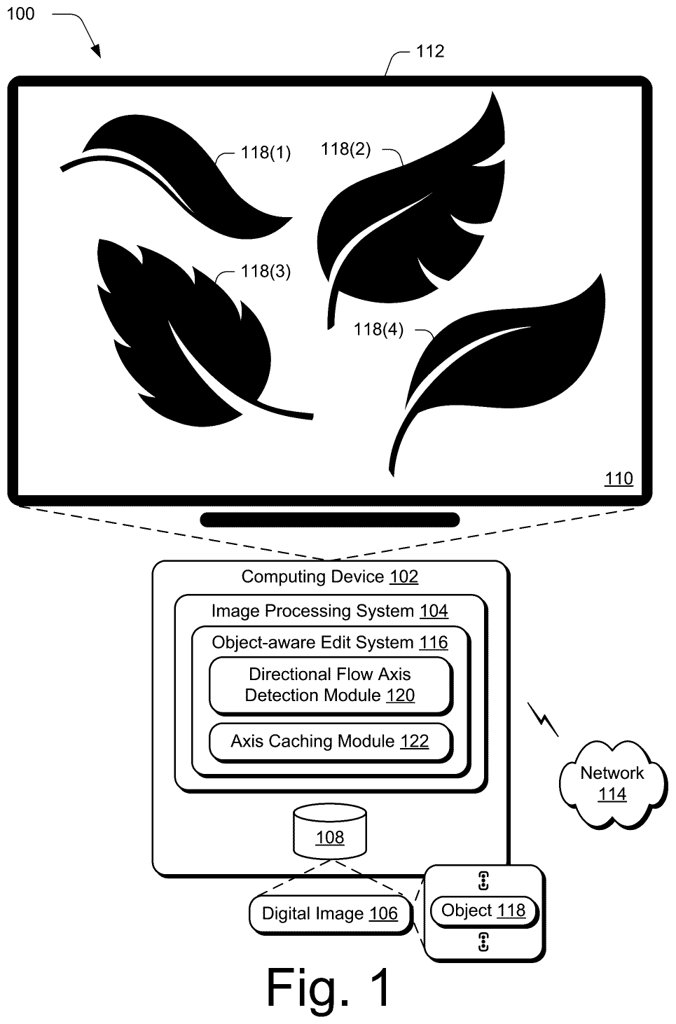

FIG. 1 is an illustration of a digital medium environment 100 in an example implementation that is operable to employ directional flow axis object control techniques described herein. The illustrated environment 100 includes a computing device 102, which is configurable in a variety of ways.

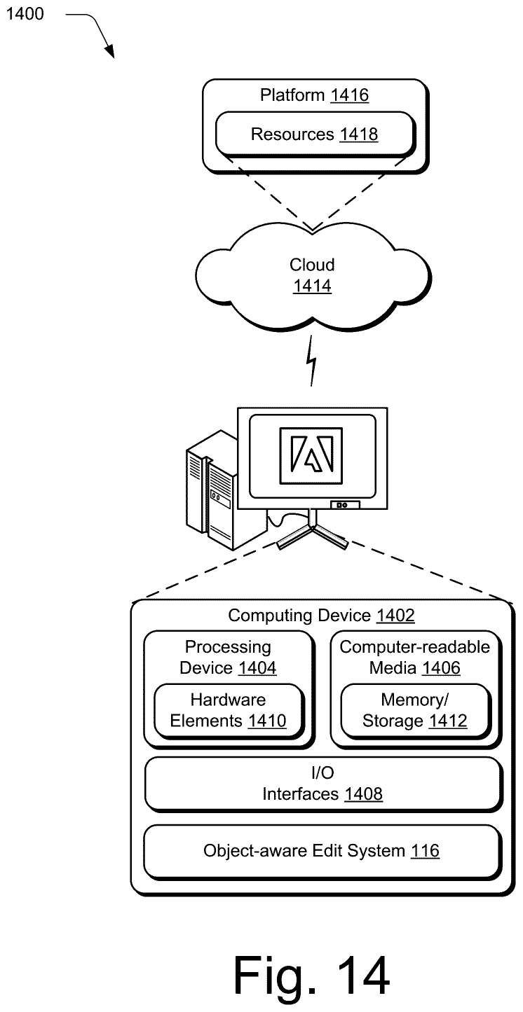

The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 14.

The computing device 102 is illustrated as including an image processing system 104. The image processing system 104 is implemented at least partially in hardware of the computing device 102 to process and transform a digital image 106, which is illustrated as maintained in a storage device 108 of the computing device 102. The digital image 106 may take a variety of forms, examples of which include portable network graphics (PNG), bitmap, graphics interchange format (GIF), raw, joint photographic experts group (JPEG), WebP, high efficiency image format (HEIF), and so forth. Examples of processing includes creation of the digital image 106, modification of the digital image 106, and rendering of the digital image 106 in a user interface 110 for output, e.g., by a display device 112. Although illustrated as implemented locally at the computing device 102, functionality of the digital content editing system 104 is also configurable as whole or part via functionality available via the network 114, such as part of a web service or “in the cloud.”

An example of functionality incorporated by the digital content editing system 104 to process the digital image 106 is illustrated as an object-aware edit system 116. The object-aware edit system 116 is configured to control edit operations involving an object 118 as part of editing the digital image 106. The object 118, for instance, is configurable as a vector object, a raster object, and so on.

The object-aware edit system 116 supports automated detection of a directional flow axis of the object 118, functionality to do so is represented by a directional flow axis detection module 120. The object-aware edit system 116 also supports techniques that improve operational performance and efficiency through use of an axis caching module 122.

Creation of a digital image 106 often involves alignment of objects, one to another, in support of a desired visual effect. Conventional techniques that support automated alignment are typically based on a rotated bounding box of the object being rotated or are based on angular straight segments present in the object, e.g., the sides of an arrow. However, instances commonly occur in which a bounding box does not accurately reflect the object (e.g., the object is skewed within the bounding box), the object does not include a straight segment, and so on.

These instances cause failure in conventional techniques such that automated alignment is not available for these objects. In the illustrated example in the user interface 110 having a first object 118(1), second object 118(2), third object 118(3), and fourth object 118(4) configured as leaves, for instance, bounding boxes generated based on a shape of a border of the objects may depart from a perceived directional flow of the objects. Further, the first, second, third, and fourth objects 118(1)-118(4) do not include straight segments to provide a basis for alignment used in conventional techniques.

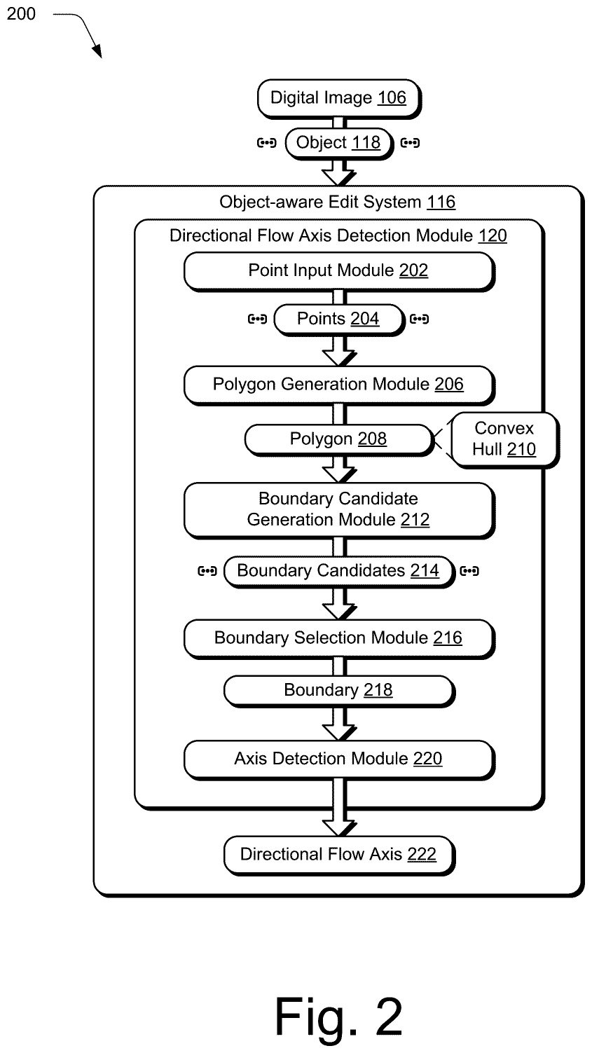

In the techniques described herein, however, the directional flow axis detection module 120 is configured to detect a directional flow axis of the first, second, third, and fourth objects 118(1)-118(4), automatically and without user intervention. The directional flow axis, for instance, is detected as following a directional flow of the objects 118, even for irregular shaped objects lacking straight segments as shown in the illustrated example. As a result, the directional flow axis provides hints as to an underlying shape of a respective object, which supports a variety of edit operations such as a snapping operation to align directional flow axis of the objects to each other, output of visual guides, and so on. Further discussion of directional flow axis detection may be found in relation to FIGS. 2-8.

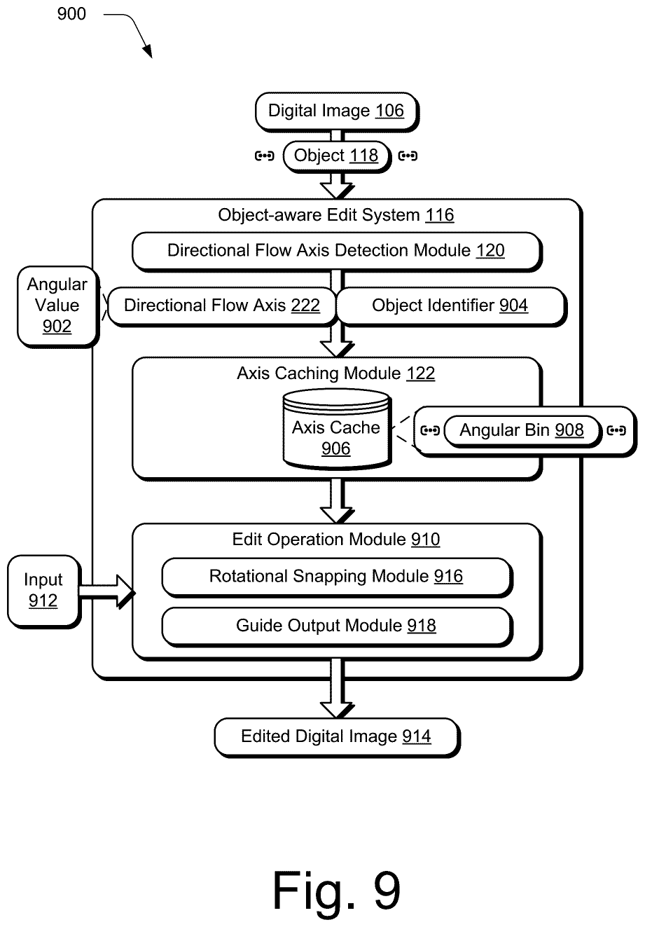

The axis caching module 122 is also usable by the object-aware edit system 116 in support of directional flow axes and operations that leverage the directional flow axes. The axis caching module 122, for instance, is configurable to maintain an axis cache having values of directional flow axis for respective objects maintained in respective angular bins. Caching of the directional flow axis in respective bins improves operational performance in support of real time operation of edit operations, e.g., to support snapping behaviors and output of visual guides as an input is received involving object movement in the user interface 110. Further discussion of caching examples may be found in relation to FIGS. 9-13.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Directional Flow Axis Detection

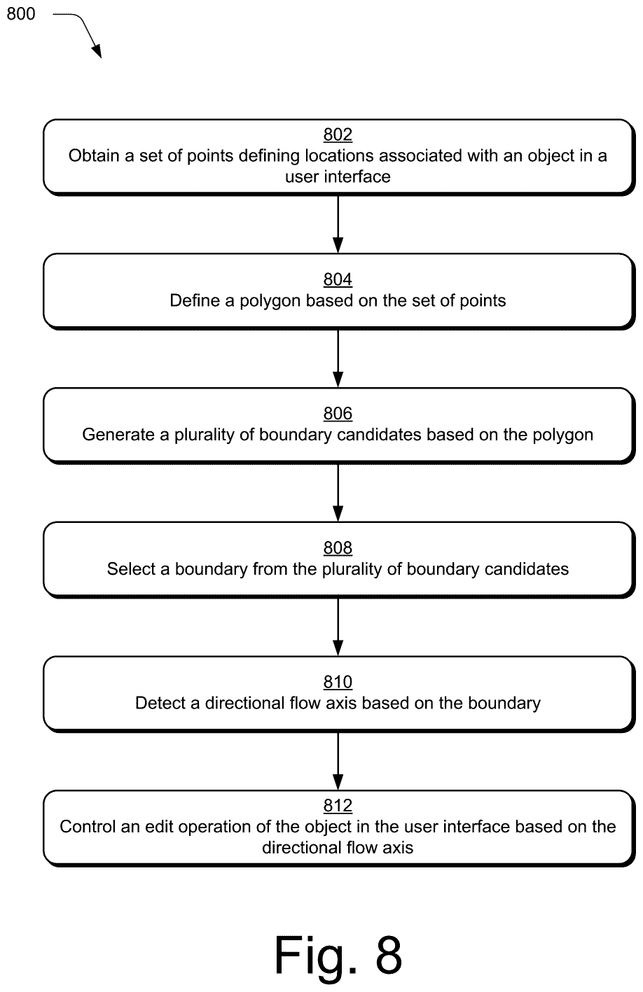

The following discussion describes directional flow axis detection techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 8 is a flow diagram depicting an algorithm 800 as a step-by-step procedure in an example implementation of operations performable for accomplishing a result of detection of a directional flow axis of an object and control of an edit operation based on the directional flow axis. The following discussion is made in parallel with the algorithm 800 of FIG. 8.

FIG. 2 depicts a system 200 in an example implementation showing operation of the directional flow axis detection module 120 of FIG. 1 in greater detail as detecting a directional flow axis of an object in a digital image 106. To begin in this example, an object 118 is received from a digital image 106. The object 118, for instance, is selected via the user interface 110, processed upon opening of the digital image 106 (e.g., for display in the user interface 110), and so forth.

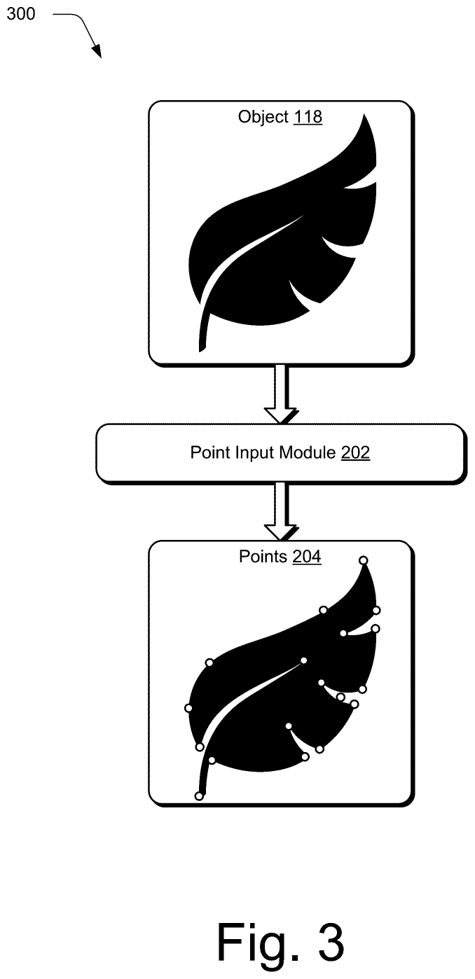

A point input module 202 is then employed by the directional flow axis detection module 120 to obtain a set of points defining locations associated with the object 118 in the user interface 110 (block 802). FIG. 3 depicts a system 300 in an example implementation showing operation of the point input module 202 of FIG. 2 in greater detail as obtaining the set of points 204.

The point input module 202, for instance, identifies the object 118 and detects the set of points 204 associated with the object 118. The set of points 204, for instance, include points that are usable to define segments of the object 118, e.g., control points and/or vertex usable to define segments of a vector object. The set of points 204 is also configurable based on coordinates associated with the object 118, e.g., as minimum and maximum values of “X” and “Y” coordinates, a center of a bounding box formed by these values, and so forth. In the illustrated example, the set of points 204 define line segments of the object 118 as well as the minimum and maximum coordinate values for a leaf.

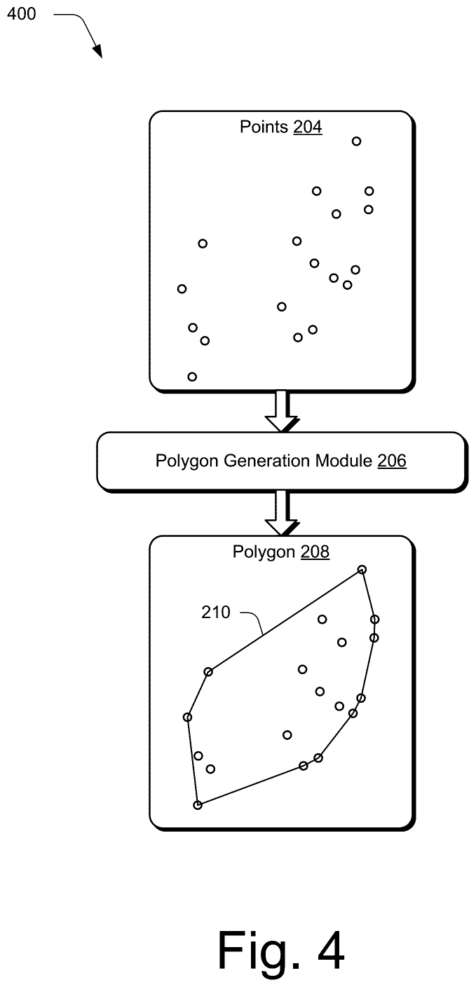

The set of points 204 are then received as an input by a polygon generation module 206 to define a polygon 208 based on the set of points (block 804), e.g., as a convex hull 210. FIG. 4 depicts a system 400 in an example implementation showing operation of the polygon generation module 206 of FIG. 2 in greater detail as defining a polygon 208 based on the set of points 204. The polygon 208 is defined in this example using a plurality of segments (e.g., line segments such as Bezier curves) defined by connections between respective points to define a closed shape. The closed shape encompasses the set of points 204, e.g., through inclusion as part of a border of the shape or within the border of the shape.

In the illustrated example, the polygon 208 is formed as a convex hull 210. The convex hull 210 is convex, which indicates that for any two points inside the convex hull 210, a line segment connecting those two points is also entirely inside the convex hull 210. The convex hull 210 is a smallest form of a polygon 208 that is configurable to enclose the set of points 204. Examples of techniques usable by the polygon generation module 206 to form the convex hull 210 include Graham's scan, Jarvis march algorithm, and so on.

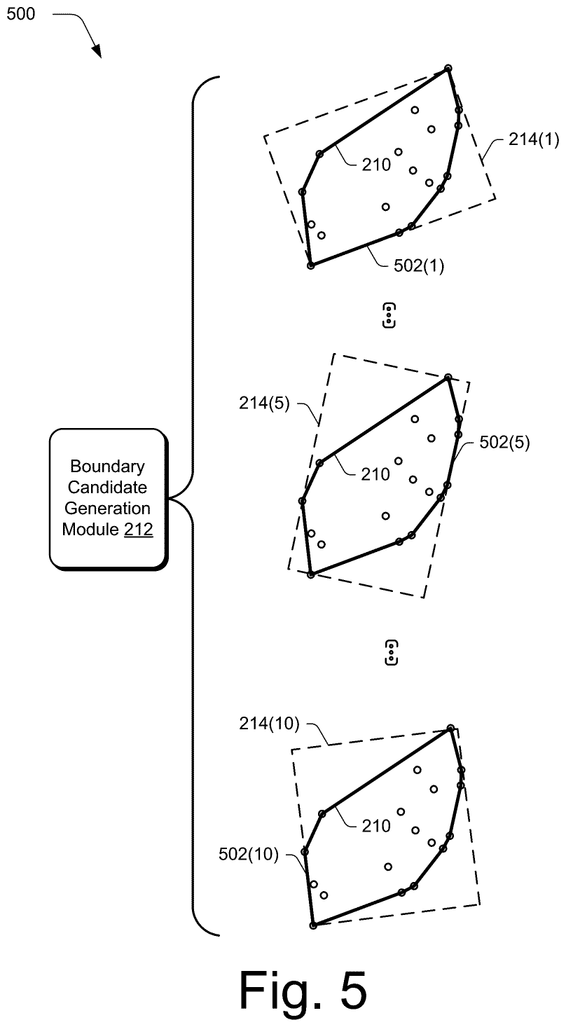

The polygon 208 is then passed as an input to a boundary candidate generation module 212. The boundary candidate generation module 212 is configured to generate a plurality of boundary candidates 214 based on the polygon 208 (block 806). FIG. 5 depicts a system 500 in an example implementation showing operation of the boundary candidate generation module 212 of FIG. 2 in greater detail as generating the plurality of boundary candidates 214 based on the polygon 208. The polygon 208 in this example includes ten segments. In order the generate the plurality of boundary candidates 214, the boundary candidate generation module 212 rotates the convex hull 210 (i.e., the polygon 208) along each of the segments, i.e., sides of the polygon 208. The boundary candidate generation module 212 then forms a rectangle that encloses the convex hull 210 and has a side that corresponds to a respective segment.

A first boundary candidate 214(1), for example, is generated by the boundary candidate generation module 212 for a first side 502(1) of the convex hull 210. Likewise, a fifth boundary candidate 214(5) is generated by the boundary candidate generation module 212 for a fifth side 502(5) of the convex hull 210. This process continues until a tenth boundary candidate 214(10) is generated for a ten side 502(10) of the convex hull 210. Thus, in this example the boundary candidate generation module 212 generates a first boundary candidate 214(1) through a tenth boundary candidate 214(10) for each of the sides of the convex hull 210.

The plurality of plurality of boundary candidates 214 are then passed form the boundary candidate generation module 212 to a boundary selection module 216. The boundary selection module 216 is tasked with selecting a boundary 218 from the plurality of boundary candidates 214 (block 808). An axis detection module 220 is then employed by the directional flow axis detection module 120 to detect a directional flow axis 222 based on the boundary 218 (block 810), which is used as a basis to control an edit operation of the object 118 in the user interface 110 based on the directional flow axis 222 (block 812).

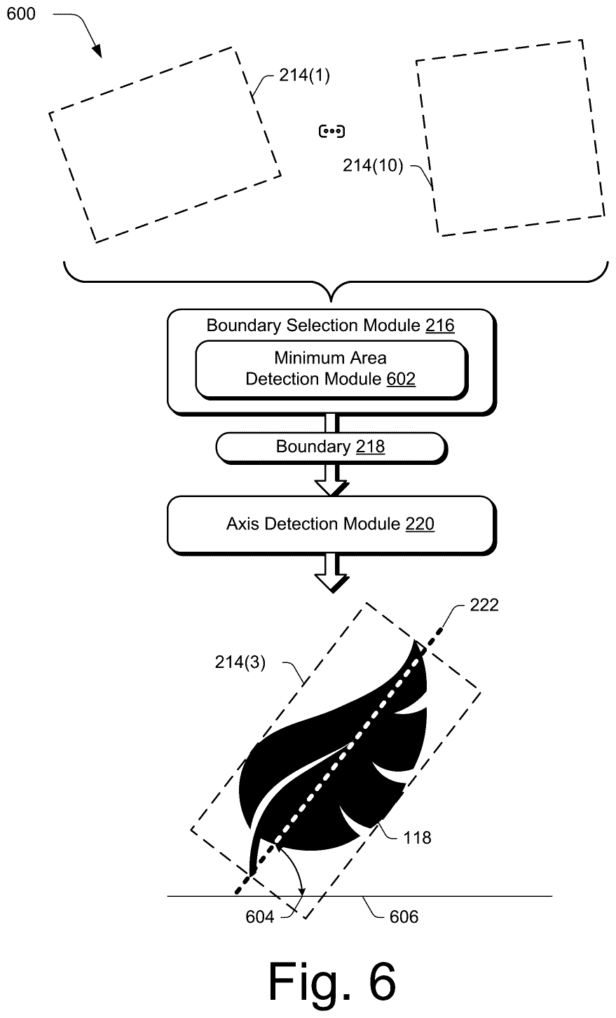

FIG. 6 depicts a system 600 in an example implementation showing operation of the boundary selection module 216 and axis detection module 220 of FIG. 2 in greater detail as detecting a directional flow axis 222. The boundary selection module 216 continues the example of FIG. 5 in which a first boundary candidate 214(1) through a tenth boundary candidate 214(10) are received by the boundary selection module 216, one for each side of the polygon 208.

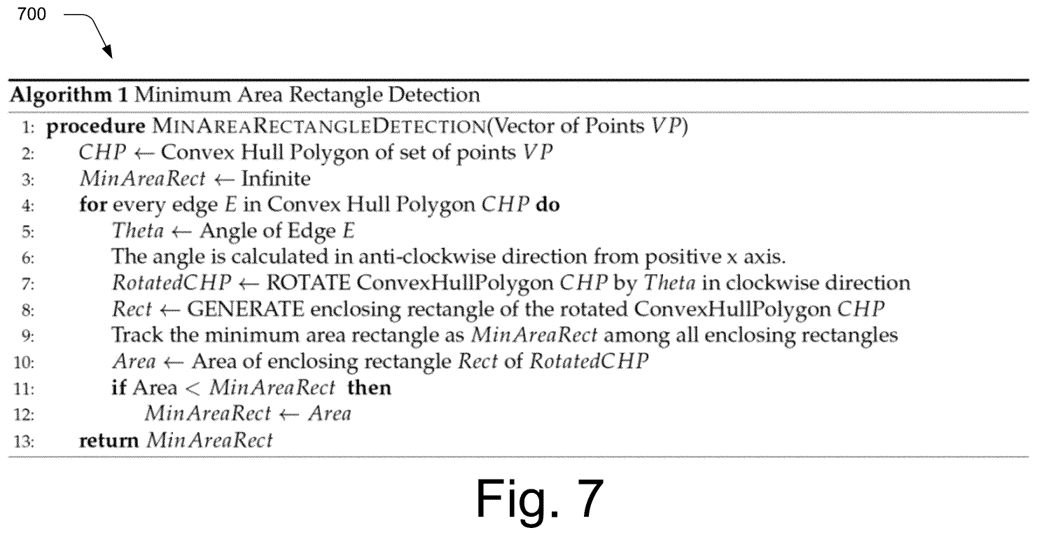

The boundary selection module 216 then employs a minimum area detection module 602 to determine an amount of area defined within each of the plurality of boundary candidates and select the boundary 218 having the amount of area that is lowest, respectively. In other words, the minimum area detection module 602 selects the boundary 218 as having the minimum amount of area from the plurality of boundary candidates 214. FIG. 7 depicts an example algorithm 700 describing minimum area rectangle detection following generation of the convex hull 210 and definition of the plurality of boundary candidates 214.

The boundary 218 is then used as a basis to detect the directional flow axis 222 by the axis detection module 220. To do so in the illustrated example, a third boundary candidate 214(3) is selected as the boundary 218 by the boundary selection module 216 for the object 118. The boundary 218 defines two axes defined by perpendicular sides of the rectangle. The axis associated with the longest side is selected as the directional flow axis 222, which is depicted through a center of the boundary 218 as a visual guide. The directional flow axis 222 is associated with an angular value 604 with respect to a reference axis 606 in the illustrated example, which supports caching for improvement in subsequent edit operations, further discussion of which is included in the following section and shown in corresponding figures.

### Directional Flow Axis Caching and Edit Operations

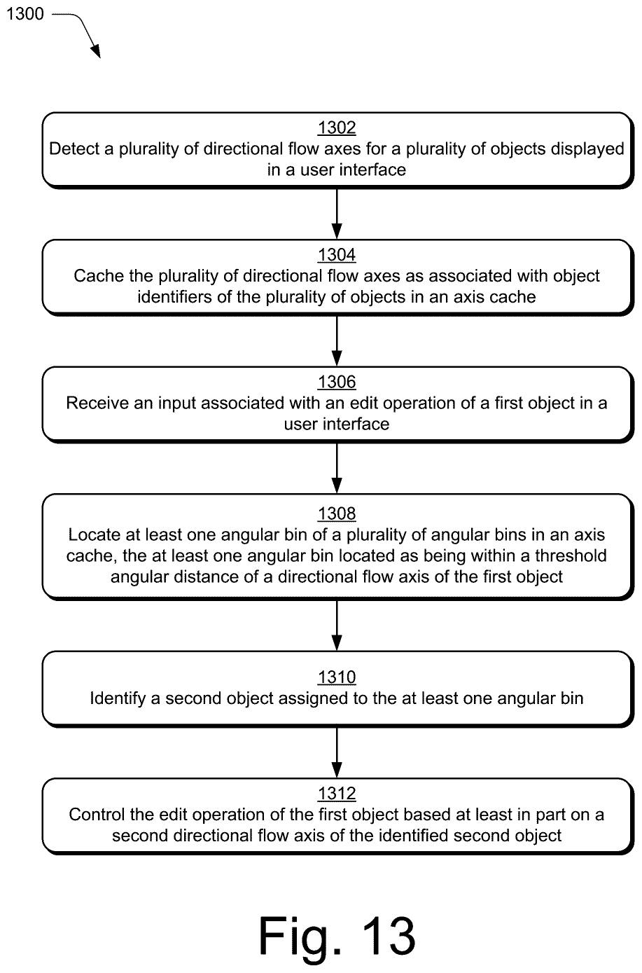

The following discussion describes directional flow axis caching techniques and edit operations that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 13 is a flow diagram depicting an algorithm 1300 as a step-by-step procedure in an example implementation of operations performable for accomplishing a result of directional flow axis caching in support or real time edit operations. The following discussion is made in parallel with the algorithm 1300 of FIG. 13.

FIG. 9 depicts a system 900 in an example implementation showing operation of the object-aware edit system 116 of FIG. 1 in greater detail as employing an axis cache to support storage of directional flow axis 222 generated by the directional flow axis detection module 120. In this example, the directional flow axis detection module 120 is implemented to detect a plurality of directional flow axes for a plurality of objects displayed in a user interface (block 1302). For each directional flow axis 222, the directional flow axis detection module 120 generates an angular value 902 as shown in FIG. 6 along with an object identifier 904 of an object associated with the directional flow axis 222.

An axis caching module 122 is then employed to cache the plurality of directional flow axis 222 as associated with object identifiers 904 of the plurality of objects in an axis cache 906 (block 1304). The axis cache 906 is a data structure that is utilized to increase performance and efficiency in access to the directional flow axis 222 in order to implement edit operations.

For example, a determination is made as to whether the objects have a similar slope, i.e., angular value. To do so, a determination is made as to whether an object that is subject of an operation (e.g., selection and movement in a user interface 110) has become parallel within a threshold amount of a directional flow access of another object in the user interface 110. However, performing iterations over each object's directional flow axis during the edit operation adds to time complexity of overall process, which is exacerbated in instances in which when object count is relatively high.

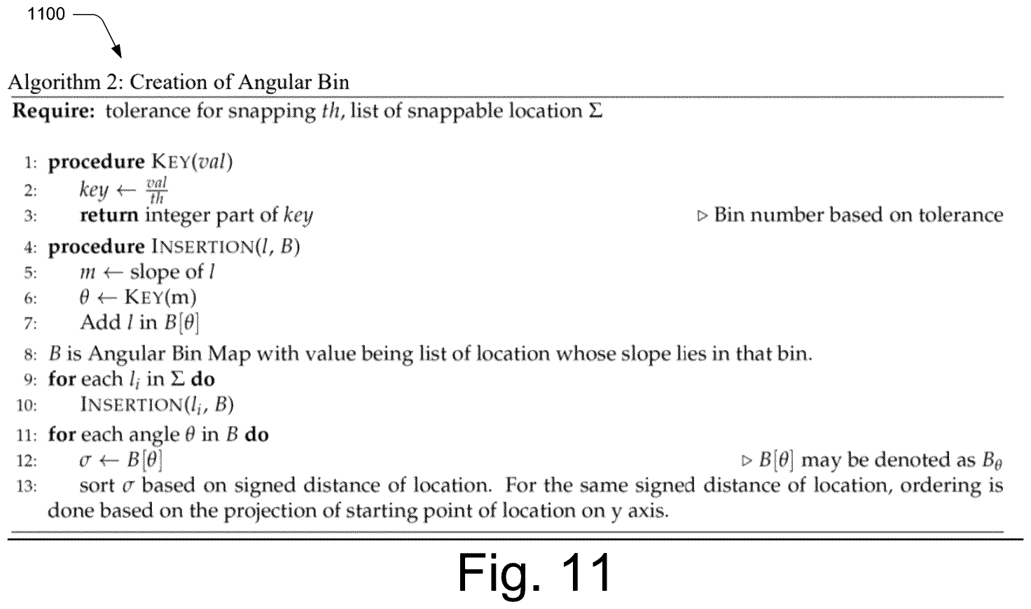

Hence, in this example the axis caching module 122 caches the directional flow axis 222 of each of the objects 118 in the digital image 106 into a respective angular bin 908 based on a corresponding angular value (e.g., slope) in relation to a coordinate axis. The total number of bins may be set based on a snapping tolerance “e.” Within each respective angular bin 908, the directional flow axis 222 are sorted based on a respective signed distance from origin for further efficiency. FIG. 11 depicts an example algorithm 1100 illustrating creation of angular bins for use by the axis cache 906.

The axis cache 906 is then utilized to support real time performance of edit operations involving directional flow axis object control. An edit operation module 910, for instance, receives an input 912 associated with an edit operation of a first object in a user interface (block 1306). The edit operation module 910 locates an at least one angular bin 908 of a plurality of angular bins in the axis cache 906. The at least one angular bin is located by the edit operation module 910, for instance, as being within a threshold angular distance of a directional flow axis 222 of the first object (block 1308). The edit operation module 910 identifies a second object assigned to the at least one angular bin (block 1310) and controls the edit operation of the first object based at least in part on a second directional flow axis of the identified second object obtained from the at least one angular bin (block 1312) as part of generating an edited digital image 914. The edit operation module 910 supports a variety of functionality based on the directional flow axis 222, examples of which include a rotational snapping operation as implemented by a rotational snapping module 916, a visual guide as generated by a guide output module 918, and so forth.

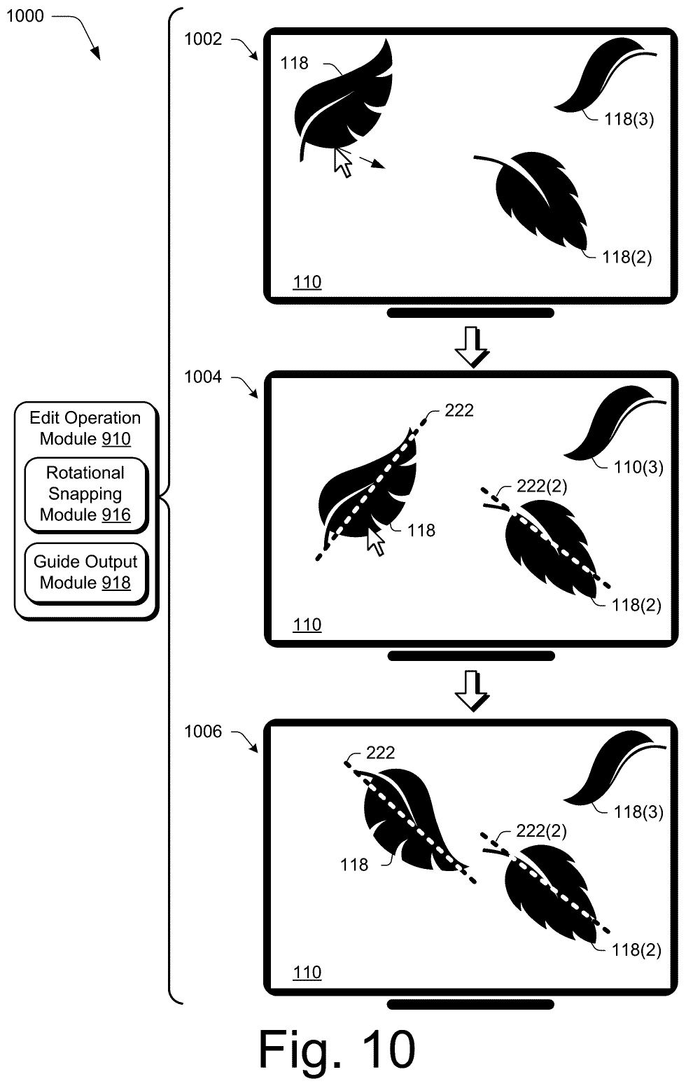

FIG. 10 depicts a system 1000 in an example implementation showing operation of the edit operation module 910 of FIG. 9 in greater detail as implementing an edit operation based on a directional flow axis 222. This example is illustrated using a first stage 1002, a second stage 1004, and a third stage 1006. At the first stage 1002, an input is received via a cursor control device that selects an object 118 in a user interface 110. The object 118, for instance, is selected and subject of movement in the user interface 110, which is illustrated using a dashed line.

At the second stage 1004, the object 118 is moved within a threshold distance of a second object 118(2) in the user interface 110, but is not within a threshold distance of a third object 118(3). In response, the guide output module 918 outputs a visual guide indicative of the directional flow axis 222 of the object 118 and a second directional flow axis 222(2) of the second object 118(2). In this way, the guide output module 918 provides feedback via the user interface 110 to indicate that the second object 118(2) and not the third object 118(3) is to be subject of the snapping operation. Other examples of visual guides are also contemplated, such as depiction in the user interface 110 of the rectangles generated as a respective boundary candidate as shown in FIG. 5.

At the third stage 1006, upon release of the input the rotational snapping module 916 aligns the directional flow axis 222 of the object 118 with the second directional flow axis 222(2) of the second object 118(2). This causes the object 118 in this example to rotate and “snap” such that the directional flow axis 222 of the object 118 is parallel with the second directional flow axis 222(2) of the second object 118(2).

In order to improve efficiency in performance of the snapping operation in this example, the edit operation module 910 utilizes the axis cache 906. The axis cache 906 includes a list of directional flow axis defined for the objects as described above. For a particular angular value of a rotational angle “A” of the object 118, for instance, the edit operation module 910 filters this list of directional flow axis maintained in the axis cache 906. To do so, the edit operation module 910 utilizes a threshold based on the angular value to select one or more of the angular bins 908. From these candidates, the edit operation module 910 identifies the second object as the winning candidate based on different of angular values associated with the object 118 and the second object.

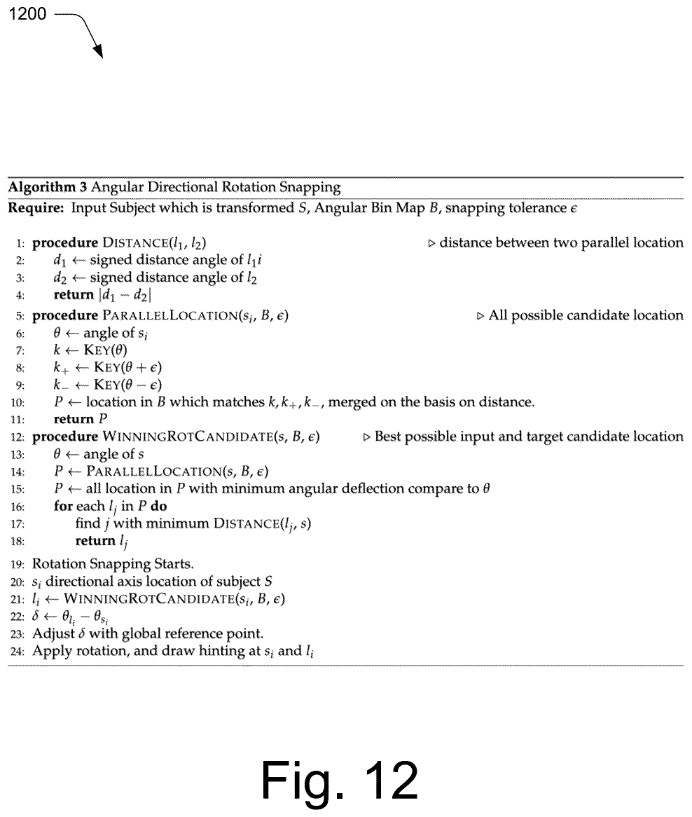

For the snapping operation, the rotational snapping module 916 determines a difference in angle between the directional flow axis 222 of the object 118 and the second directional flow axis 222(2) of the second object 118(2). This difference (i.e., the “delta”) is used to adjust the directional flow axis 222 of the object 118 in this example (e.g., about a hinge point of rotation) to precisely snap the object 118. FIG. 12 depicts an example algorithm 1200 illustrating use of the axis cache 906 as part of an angular directional rotation snapping operation. Similar functionality is employed by the guide output module 918 to control output of visual guides using the axis cache 906, e.g., when within a threshold distance of the second object 118(2).

### Example System and Device

FIG. 14 illustrates an example system generally at 1400 that includes an example computing device 1402 that is representative of one or more computing systems and/or devices that implement the various techniques described herein. This is illustrated through inclusion of the object-aware edit system 116. The computing device 1402 is configurable, for example, as a server of a service provider, a device associated with a client (e.g., a client device), an on-chip system, and/or any other suitable computing device or computing system.

The example computing device 1402 as illustrated includes a processing device 1404, one or more computer-readable media 1406, and one or more I/O interface 1408 that are communicatively coupled, one to another. Although not shown, the computing device 1402 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1404 is representative of functionality to perform one or more operations using hardware. Accordingly, the processing device 1404 is illustrated as including hardware element 1410 that is configurable as processors, functional blocks, and so forth. This includes implementation in hardware as an application specific integrated circuit or other logic device formed using one or more semiconductors. The hardware elements 1410 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1406 is illustrated as including memory/storage 1412 that stores instructions that are executable to cause the processing device 1404 to perform operations. The memory/storage 1412 represents memory/storage capacity associated with one or more computer-readable media. The memory/storage 1412 includes volatile media (such as random access memory (RAM)) and/or nonvolatile media (such as read only memory (ROM), Flash memory, optical disks, magnetic disks, and so forth). The memory/storage 1412 includes fixed media (e.g., RAM, ROM, a fixed hard drive, and so on) as well as removable media (e.g., Flash memory, a removable hard drive, an optical disc, and so forth). The computer-readable media 1406 is configurable in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1402 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1402. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1402, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1410. The computing device 1402 is configured to implement particular instructions and/or functions corresponding to the software and/or hardware modules. Accordingly, implementation of a module that is executable by the computing device 1402 as software is achieved at least partially in hardware, e.g., through use of computer-readable storage media and/or hardware elements 1410 of the processing device 1404. The instructions and/or functions are executable/operable by one or more articles of manufacture (for example, one or more computing devices 1402 and/or processing devices 1404) to implement techniques, modules, and examples described herein.

The techniques described herein are supported by various configurations of the computing device 1402 and are not limited to the specific examples of the techniques described herein. This functionality is also implementable all or in part through use of a distributed system, such as over a “cloud” 1414 via a platform 1416 as described below.

The cloud 1414 includes and/or is representative of a platform 1416 for resources 1418. The platform 1416 abstracts underlying functionality of hardware (e.g., servers) and software resources of the cloud 1414. The resources 1418 include applications and/or data that can be utilized while computer processing is executed on servers that are remote from the computing device 1402. Resources 1418 can also include services provided over the Internet and/or through a subscriber network, such as a cellular or Wi-Fi network.

The platform 1416 abstracts resources and functions to connect the computing device 1402 with other computing devices. The platform 1416 also serves to abstract scaling of resources to provide a corresponding level of scale to encountered demand for the resources 1418 that are implemented via the platform 1416. Accordingly, in an interconnected device embodiment, implementation of functionality described herein is distributable throughout the system 1400. For example, the functionality is implementable in part on the computing device 1402 as well as via the platform 1416 that abstracts the functionality of the cloud 1414.

In implementations, the platform 1416 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
obtaining, by a processing device, a set of points defining locations associated with an object in a user interface;
defining, by the processing device, a polygon based on the set of points;
generating, by the processing device, a plurality of boundary candidates based on the polygon;
selecting, by the processing device, a boundary from the plurality of boundary candidates;
detecting, by the processing device, a directional flow axis based on the boundary; and
controlling, by the processing device, an edit operation of the object in the user interface based on the directional flow axis.

2. The method as described in claim 1, wherein the set of points include:
at least one point used to define a vertex of a border of the object; or
a maximum or minimum value of a coordinate of the object in the user interface.

3. The method as described in claim 1, wherein the polygon is formed as a convex hull based on the set of points.

4. The method as described in claim 1, wherein the polygon includes a plurality of segments defined by connections between respective said points to define a closed shape.

5. The method as described in claim 1, wherein the plurality of boundary candidates corresponds, respectively, to a plurality of segments used to form the polygon.

6. The method as described in claim 5, wherein the plurality of boundary candidates is formed as a bounding box having a side that corresponds to a respective said segment and encompasses the set of points.

7. The method as described in claim 1, wherein the selecting of the boundary includes:
determining an amount of area defined within each of the plurality of boundary candidates; and
selecting the boundary from the plurality of boundary candidates having the amount of area that is lowest, respectively.

8. The method as described in claim 1, further comprising caching the directional flow axis and an object identifier of the object in an axis cache and wherein the controlling is performed using the axis cache.

9. The method as described in claim 8, wherein the directional flow axis is cached in a respective angular bin of a plurality of angular bins defined within the axis cache.

10. The method as described in claim 1, wherein the controlling includes a snapping operation in which the object is rotated in relation to an additional object in the user interface by aligning the directional flow axis of the object with a directional flow axis of the additional object.

11. The method as described in claim 1, wherein the controlling includes output of a visual guide in the user interface indicating the directional flow axis in relation to the object.

12. A computing device comprising:
a processing device; and
a computer-readable storage medium storing instructions that, responsive to execution by the processing device, causes the processing device to perform operations including:
receiving an input associated with an edit operation of a first object in a user interface;
locating at least one angular bin of a plurality of angular bins in an axis cache, the at least one angular bin located as being within a threshold angular distance of a directional flow axis of the first object;
identifying a second object assigned to the at least one angular bin; and
controlling the edit operation of the first object based at least in part on a second directional flow axis of the identified second object obtained from the at least one angular bin.

13. The computing device as described in claim 12, wherein the plurality of angular bins corresponds, respectively, to a range of angular values.

14. The computing device as described in claim 12, wherein the second object is located from a plurality of objects assigned to the at least one angular bin based on respective distances to the first object in the user interface.

15. The computing device as described in claim 12, wherein the edit operation includes a snapping operation in which a first said object is rotated in relation to a second said object in the user interface by aligning a first said directional flow axis of the first said object with a second said directional flow axis of the second said object.

16. The computing device as described in claim 12, wherein the edit operation includes output of a visual guide in the user interface indicating a respective said directional flow axis in relation to a respective said object.

17. One or more computer-readable storage medium storing instructions that, responsive to execution by a processing device, causes the processing device to perform operations including:
detecting a plurality of directional flow axis for a plurality of objects displayed in a user interface;
caching the plurality of directional flow axis as associated with object identifiers of the plurality of objects in an axis cache; and
controlling at least one edit operation based on the axis cache.

18. One or more computer-readable storage medium as described in claim 17, wherein the plurality of directional flow axis is cached in a respective angular bin of a plurality of angular bins defined within the axis cache.

19. One or more computer-readable storage medium as described in claim 17, wherein the controlling of the at least one edit operation includes a snapping operation in which a first said object is rotated in relation to a second said object in the user interface by aligning a first said directional flow axis of the first said object with a second said directional flow axis of the second said object.

20. One or more computer-readable storage medium as described in claim 17, wherein the controlling of the at least one edit operation includes output of a visual guide in the user interface indicating a respective said directional flow axis in relation to a respective said object.
